(19) United States
(12) Patent Application Publication
(10) Pub. No.: US 2020/0125657 A1
(43) Pub. Date: Apr. 23, 2020

(54) EFFICIENT DETERMINATION OF CHANGED DATA IN A SQL DATABASE TO SUPPORT ODATA DELTA RESPONSES

(71) Applicant: SAP SE, Walldorf (DE)

(72) Inventors: Michael Thode, Waterloo (CA); Matthew Borges, Kitchener (CA)

(21) Appl. No.: 16/166,863

(22) Filed: Oct. 22, 2018

(51) Int. Cl. G06F 17/30; H04L 29/08

(52) U.S. Cl. CPC G06F 17/30368; G06F 17/30522; H04L 67/02; G06F 17/3033; G06F 17/30371

(57) ABSTRACT

Disclosed herein are system, method, and computer program product embodiments for efficiently determining a delta of changed data in response to a refresh request from a data consuming application received by a data producing application. The delta response may be formulated using an association-tracking approach or a change-logging approach. These approaches reduce the number of changes that need to be sent to the data consuming application and improve the efficiency of the replication process.

### BACKGROUND

A data consuming application may store a local copy of data retrieved from a data producing application. When the data consuming application refreshes the local data, instead of downloading all relevant data anew, the data consuming application may retrieve only the changed records, i.e., a delta of changes that occurred in the data producing application since the last retrieval by the data consuming application. By retrieving only the delta of modified data and applying the delta to a local copy of the data, data may be efficiently retrieved, replicated, and maintained between the data consuming application and the data producing application.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art(s) to make and use the embodiments.

FIG. 1 is a schematic block diagram showing an example system including a data consuming application and a data producing application, according to some embodiments.

FIG. 2 is a flowchart illustrating a method of determining a delta response via a change logging approach, according to some embodiments.

FIG. 3 is a flowchart illustrating a method of determining a delta response via an association-based approach, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for efficiently determining a delta of changed data in a data producing application in response to a refresh request from a data consuming application.

A data producing application may be a user interface, device, application, or other system that assembles, collects, manipulates, stores, and/or archives data. A data producing application may then furnish the accumulated data to ancillary applications and users thereof through a suitable interface, application programming interface, querying mechanism, and/or other suitable protocol, for example, OData. The range, nature, and character of data producing applications is expansive and spans multitudinous industries, services, trades, and pursuits. A data producing application may take numerous forms and rely on varied technologies to capture, retain, store, and present accumulated data to interested users.

A user may employ a device, for example, a mobile device, to connect to a data producing application to view, manipulate, explore, and/or otherwise interact with data in the data producing application. An application may run on the device that retrieves, organizes, manipulates, and displays the data. Such an application may be referred to as a data consuming application. After initially connecting to the data producing application, the device may store a local copy of the data retrieved from the data producing application. This local copy of the data may remain available (only to the device and applications running thereon) when the device is offline, i.e., when the data consuming application is unable to communicate with the data producing application. Thus, full operation of the data consuming application may continue even though the data consuming application may no longer communicate with the data producing application. Storing a local copy may improve the performance of interactions with the data, facilitate additional manipulating, organizing, or visualizing, and allow the user to interact with the data in the local copy when the device is offline.

However, changes may occur in the source data, i.e., the data provided by the data producing application, while the device is offline or not otherwise connected to or interacting with the data producing application. Thus, at a later point in time, the device may need to reconnect to the data producing application in order to receive an updated copy of the data in the data producing application and bring the local data again into harmony with the source data.

During a first connection, i.e., an initialization process, between the device and the data producing application, the device may retrieve or download an entire copy of the data or portions of the data. The portions of the data that a user may access may be controlled by various access permissions and security parameters. The portions may be limited using a filtering predicate, described in further detail below. However, completing a full download of the dataset may be a time-consuming endeavor when the datasets are large. While this may be an acceptable requirement during the initialization process, for subsequent connections, downloading the full dataset in its entirety anew may be frustrating for users and/or otherwise not practical.

Thus, in order to avoid a time-consuming retrieval of a large amount of records, the device may retrieve only a delta, i.e., a set of changes that occurred since the last time that the device retrieved the data. The delta describes the changes that need to be made to bring the local copy of the database up-to-date with the data producing application's master/source copy. By retrieving only the delta and applying those changes to the local copy of the database to bring it into harmony with the data producing application, the device may expedient the process of refreshing and synchronizing its local data.

In many use cases, a device or user may not have access to the entirety of the data in the data producing application. Instead, a device may only have access to a certain subset of data in the data producing application. The device may provide to the data producing application a filter (or the data application may apply a filter to the device) in order to limit the data retrieved in accordance with user access permissions. The filter may be a predicate, i.e. an expression that evaluates to true or false as used in SQL clauses such as WHERE, FROM, etc., or a collection of such predicates connected with Boolean logic and may be referred to below as a filtering predicate. In one exemplary illustration, the filtering predicate may include a user ID to limit the data pulled from tables and provided to the user, e.g. “WHERE table.UserID=x.” This is merely exemplary, however, and one skilled in the art(s) will appreciate that a filtering predicate may include and exhibit further complexity or filter data in a panoply of fashions.

A filtering predicate may be compound and include more than one limitation, e.g., a user in an application may have access to a particular type of shop and only shops within a particular geographic region. In this example, a filtering predicate may be “WHERE shop.TypeD=‘x’ and shop.RegionlD=‘y’.” Many other approaches exist to limit data that users may view in a data consuming application and the nature of these filtering predicates will differ greatly between applications and according to the data contained in the data producing applications.

In formulating a delta response, a data producing application may consider any filtering predicates applicable to the requesting user or client device. However, in sending the records, a data producing application may send more records than are necessary in order to avoid data loss. In other words, the accuracy of the resultant updated local copy is of paramount concern. In legacy systems and approaches, redundant updates may be sent to the data consuming application in the interest of avoiding such data loss. However, there is a performance tradeoff in sending and applying additional updates, i.e., by sending redundant transactions, a user may experience longer refresh times when refreshing the local copy of the data. Moreover, in legacy systems and approaches, some scenarios may arise where the data producing application is unable to fully determine the precise set of changed data, and the data producing application may only determine that there is a possibility the data might have changed.

One approach employed previously to determine a delta response may be referred to as a simple timestamp approach. In the simple timestamp approach, database tables in the data producing application may include a timestamp column. Each time that a record is modified in the data producing application, the data producing application updates the timestamp to match the time of the modification. The actual timestamp update may be accomplished using database triggers, thus obviating any need to rewrite any application level code to update the timestamp when making changes.

In the simple timestamp approach, when providing the delta response to a refresh request, the data producing application retrieves only the records in the database table(s) where the timestamp is later than the last download time. The last download time may be sent by the data consuming application and may reflect the last time that the user requested a refresh of the data from the data producing application. In this approach, special exceptions must be implemented for deleted records. Specifically, where a record was deleted in the data producing application, a notification must be sent to the device so that the device knows to delete the row from the local copy. This notification will be referred to herein as a tombstone.

An especially problematic scenario in which the simple timestamp approach may perform inefficiently may be referred to as the territory realignment problem. The territory realignment problem may take several forms, but in essence, occurs when a large amount of updates are made in an information system upon a change of circumstances. By way of an illustrative example, a user in an example system may be assigned to a “region,” and the user is responsible for sales of “items” at “shops” in the “region.” When the user switches regions, the delta response may grow to be very large because of the significant updates and tombstones that need to be included to reflect the changes. In this example, the user may no longer have access to any of the same “items” or any of the same “shops.” A tombstone would need to be sent for each of the records that the user previously could access, and insertions would be made for all of the records that the user now can access. Moreover, a system may have no way of knowing which records the user could previously access, and thus a tombstone may need to be sent for all rows in the table.

In another example of the territory realignment problem, an item may be transferred to a different shop to which a user no longer has access according to the filtering predicate. The data producing application needs to deduce that a tombstone needs to be sent for this item's movement, despite the fact that the item was not actually deleted in the database. When the data producing application does not know the previous data state, the data producing application must include in the delta response a tombstone or entity for every row in the table.

This concept is best illustrated with an illustrative example. For instance, a device may only receive “items” associated with a particular “shop.” The device may have access only to view items at a “shop” with ID=10. At some point after the last refresh, the device may transition to only have access to a “shop” with ID=11. A perfect treatment of modified rows, if the system knew the previous value of shop_ID is displayed:

| Previous Shop_ID | Current Shop_ID | |
|---|---|---|
| Value | Value | Action |
| 10 | 11 | Send the updated entity |
| Not 10 | 11 | Send a new entity |
| 10 | Not 11 | Send a tombstone |
| Not 10 | Not 11 | Do nothing |

In the above example, the previous shop_ID value is the value used in the filter predicate at the time of the last refresh, while the values in the table reflect the shop_ID of items, i.e. references to the shop_ID in other tables. However, if the previous shop_ID value is not known, then the modified rows must be sent thusly:

| Current Shop_ID | |
|---|---|
| Value | Action |
| 11 | Send the entity |
| Not 11 | Send a tombstone |

By calculating the previous data state, a data producing application may eliminate the redundancy characterized in the second table.

Two approaches for calculating the previous data state will be described below: a change logging approach and an association-based approach. The association-based approach makes use of primary key associations and delivers accurate previous data states where those primary key associations are in place. The association-based approach requires less space to track changes over time as well. However, the association-based approach requires primary key associations to exist within the dataset. A change logging approach provides a more general solution and allows accurate delta response calculations where primary key-based associations are not available. The change logging approach is more space intensive.

Accordingly, a need exists to accurately and efficiently calculate a previous data state when a device last refreshed its local copy of data and compare this previous data state to the current data state to calculate an accurate and optimized delta response.

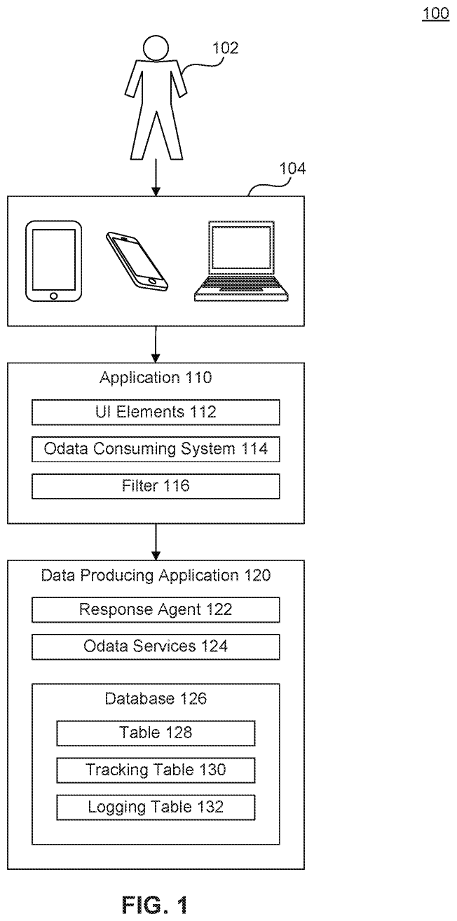

FIG. 1 illustrates a schematic block diagram showing an example system 100, according to some embodiments. System 100 may include user 102, device 104, application 110, user interface elements 112, OData consuming system 114, filter 116, data producing application 120, response agent 122, OData services 124, database 126, table 128, tracking table 130, and logging table 132.

User 102 may be an individual or entity using data-driven software applications. User 102 may be a member of a business, organization, or other suitable group using software designed to perform organizational tasks. User 102 may be an individual using software applications for personal pursuits. User 102 may be a human being, but user 102 may also be an artificial intelligence construct. User 102 may employ, i.e., connect to, a network or combination of networks including the Internet, a local area network (LAN), a wide area network (WAN), a wireless network, a cellular network, or various other types of networks as would be appreciated by a person of ordinary skill in the art.

Device 104 may be a personal digital assistant, desktop workstation, laptop or notebook computer, netbook, tablet, smart phone, mobile phone, smart watch or other wearable, appliance, part of the Internet-of-Things, and/or embedded system, to name a few non-limiting examples, or any combination thereof. Although device 104 is illustrated in the example of FIG. 1 as a single computer, one skilled in the art(s) will understand that device 104 may represent two or more computers in communication with one another. Therefore, it will also be appreciated that any two or more components of system 100 may similarly be executed using some or all of the two or more computers in communication with one another.

Application 110 may be any number of a myriad of data driven and/or data consuming software applications and may meet and serve diverse requirements. In an embodiment, application 110 may run on and/or be installed upon device 104. Application 110 may be a mobile application or other executable software program deployed to device 104. In another embodiment, application 110 may be housed on a remote server and delivered over a network to user 102. More than one application in application 110 may reside on the same remote server. User 102 may interact with application 110 through a web browser or interface such as Chrome, Firefox, etc. via device 104. User 102 may also interact with application 110 through a mobile application, desktop application, or other suitable software interface. Application 110 may serve a particular function, purpose, or goal, but not necessarily. Application 110 may include dynamic interactions with user 102 through user input and data processing, but application 110 may merely relay information without receiving inputs from user 102. Throughout this disclosure, examples will be referred to of an application that addresses “users,” “shops,” “items,” and “regions.” However, these are merely illustrative, and the breadth of functionality provided by application 110 will be appreciated by one skilled in the relevant art(s) to be expansive.

User interface elements 112 may provide components that render a user interface for view by user 102 on device 104. User interface elements 112 may include a JavaScript library or other user interface library to facilitate dynamic interactions between user 102 and application 110. User interface elements 112 may include a development toolkit facilitating the building and deployment of HTML5 applications or mobile applications. User interface elements 112 may include appropriate stylesheets and design formats to shape, for example, the display format of data retrieved from data producing application 120.

OData consuming system 114 may provide tools allowing application 110 to retrieve and interact with data contained in data producing application 120. OData consuming system 114 may formulate appropriate open data protocol requests in order to retrieve data for display in application 110 using user interface elements 112. In an embodiment, OData consuming system 114 may further allow application 110 to manipulate data contained in data producing application 120 by updating, inserting, and deleting records.

Filter 116 may be used by data producing application 120 to identify data specific to device 104 and/or user 102, i.e., that device 104 and/or user 102 may access and view. Filter 116 may include a user identifier. Filter 116 may take the form of a simple or compound predicate used to retrieve appropriate data from data producing application 120 via OData consuming system 114. Filter 116 may be referred to throughout this disclosure as a filtering predicate.

Data producing application 120 may be a user interface, device, application, or other system that collects, manipulates, stores, and/or archives data. In an alternate embodiment, data producing application 120 and application 110 may reflect the same entity. Data producing application 120 may provide stored data to data consuming applications through a suitable interface, application programming interface, querying mechanism, and/or other suitable protocol, for example, OData. Just for example, data producing application 120 may include customer relationship management tools, enterprise resource planning tools, word processing applications, communication applications, product lifecycle management tools, supply chain management, general business solutions, and many other types of applications.

Response agent 122 may be a suitable application server, web server, or other mechanism for responding to web traffic received over appropriate communication channels. Response agent 122 may run on premise, for instance, in a hosted environment, or on the cloud. Response agent 122 may be implemented using the advanced business application programming language or other suitable high-level programming language, e.g., C/C++, Java, Perl, etc. Response agent 122 may be divided into a presentation layer (e.g., ASP, JSP, BSP, etc.), business-logic layer (e.g., J2EE runtime environment, java beans, etc.), integration layer (connecting to other application servers or APIs), connectivity layer (e.g., HTTP, HTTPS, SSL, etc.), persistence layer (e.g., SQL, etc.), and other suitable layers. Response agent 122 may authenticate incoming web traffic, interact with backend systems to formulate appropriate responses, and return these responses to application 110. Response agent 122 may use OData services 124, described in further detail below.

OData services 124 may be a REST-based protocol for querying and updating data. OData services 124 may be built on standardized technologies such as HTTP, Atom/XML, and JSON. OData services 124 may provide various functions and standardized data models. For example, OData services 124 may support CRUD (Create, Read, Update, Delete) operations for creating and consuming data. In an alternate embodiment, OData services 124 may leverage ODBC, JDBC, .NET, or other suitable access methodology.

Database 126 may be a relational database, a NoSQL database or other horizontally scaling database, or any other database adhering to a suitable database design methodology. Database 126 may harness any commercially available database management system to store data retrievable by application 110 or implemented in a custom database management system. In an embodiment, database 126 implements a centralized storage area network (SAN), network-attached storage (NAS), redundant array of independent disks, and/or any other configuration of storage devices to supply sufficient storage capacity to store database tables and supporting structures. Sufficient storage may alternatively exist in any other physically attached magnetic storage, cloud storage, or additional storage medium. In an embodiment, database 126 deploys a hard-disk interface, such as ATA, SATA, SCSI, SAS, and/or fibre for interfacing with storage mediums. Database 126 may employ tables to store data and may use a row-based or columnar organizational methodology or design. Database 126 may be an in-memory database or a database management systems that employs a disk storage mechanism.

Table 128 may store data relevant to data producing application 120 and/or database 126. A table may be a set of data elements having a specified number of columns and any number of rows. A table is typically organized in a row-based fashion, but may also be columnar or use another suitable table-design approach. An new entry in the table may be inserted as an additional row, column, or record. Table 128 may be defined using appropriate SQL or scheme definitions. A merely exemplary and illustrative table definition or schema for a “shop” table may be:

| CREATE COLUMN TABLE shop ( | |
|---|---|
| ID | bigint NOT NULL, |
| shop_name | varchar(256) NOT NULL, |
| city | varchar(256) NOT NULL, |
| manager | varchar(256) NOT NULL, |

PRIMARY KEY (ID)
)

A merely exemplary table definition or schema for a “item” table may be:

| CREATE COLUMN TABLE item ( | |
|---|---|
| ID | bigint NOT NULL, |
| item_name | varchar(256) NOT NULL, |
| shop_ID | bigint NOT NULL, |
| bigint | NOT NULL, |

PRIMARY KEY (ID)
)

In these examples, the “item” table references the “shop” table via the shop_ID column. In other words, the system tracks at which “shop” an “item” resides. These examples of table 128 will be referred to in the disclosure below.

Tracking table 130 may be a table in database 126 used to track changes made to a table in database 126. For the example “shop” table above, tracking table 130 may be specified by this illustrative schema definition:

| CREATE COLUMN TABLE shop_tracking ( | |
|---|---|
| ID | bigint NOT NULL, |
| last _modified | timestamp NOT NULL, |
| is_deleted | char(1) NOT NULL, |
| PRIMARY KEY (ID) | |
| ) | |

And for the “item” table above, tracking table 130 may be specified by:

| CREATE COLUMN TABLE item_tracking ( | |
|---|---|
| ID | bigint NOT NULL, |
| last_modified | timestamp NOT NULL, |
| is_deleted | char(1) NOT NULL, |
| PRIMARY KEY (ID) | |
| ) | |

In addition, as described below in the discussion of association-based tracking, tracking table 130 may be additionally modified to track a modified_time and is_Deleted flag for each link in a chain of primary key associations. This may resemble:

| CREATE COLUMN TABLE item_to_shop_tracking ( | |
|---|---|
| ItemID | bigint NOT NULL, |
| ShopID | bigint NOT NULL, |
| is_deleted | char(1) NOT NULL, |
| modified | timestamp NOT NULL, |

PRIMARY KEY (ItemID, ShopID)
)

In an alternate embodiment, the tracking information may be tracked directly in table 128, i.e., no separate table for tracking table 130 necessarily need be created. These examples of tracking table 130 will be referred to in the disclosure below.

When receiving a refresh request, a simple timestamp approach may be taken to produce an over-expansive delta of the changes. For example, in order to pull all changed “items” in building a delta response, a view could be used such as:

```
CREATE VIEW item_delta_view AS
SELECT
      item_tracking.last_modified,
      CASE
            WHEN item.shop_ID = 10
            THEN item_tracking.is_deleted
            ELSE ‘Y’
            END,
      item.ID,
      item.item_name,
      item.shop_ID,
      item.inventory
FROM item_tracking
JOIN item
      ON item_tracking.ID = item.ID
```

Using this approach, similar such views would pull data from multiple tables to assemble the delta response. Moreover, in this solution a tombstone would need to be sent for all rows that are not relevant to the user because there is no WHERE clause. While this may be acceptable in some applications, this may not be acceptable for all use cases.

Logging table 132 may be a table in database 126 used to log additional changes made to a table in database 126. When employing the change logging approached described in further detail below, logging table 132 may log additional information from table 128 (as compared to tracking table 130) that allows data producing application 120 to determine how the row filtered on the last download. While this may require additional space usage, logging table 132 allows a wider array of filter predicates to be evaluated against the old data to determine if a device's view of the data changed since the last download. For example, the “shop_tracking” and “item_tracking” tables above may be enhanced to track additional information from the associated table:

| CREATE COLUMN TABLE shop_log ( | |
|---|---|
| ID | bigint NOT NULL, |
| shop_name | varchar(256) NOT NULL, |
| city | varchar(256) NOT NULL, |
| manager | varchar(256) NOT NULL, |
| modified | timestamp NOT NULL, |
| is_deleted | char(1) NOT NULL, |

PRIMARY KEY (ID, modified)
)

| CREATE COLUMN TABLE item_log ( | |
|---|---|
| ID | bigint NOT NULL, |
| item_name | varehar(256) NOT NULL, |
| shop_ID | bigint NOT NULL, |
| inventory | bigint NOT NULL, |
| modified | timestamp NOT NULL, |
| is_deleted | char(1) NOT NULL, |

PRIMARY KEY (ID, modified)
)

These examples of logging table 132 will be referred to in the disclosure below. Note that in the above exemplary definitions, a timestamp for each particular column of the underlying table is included. Further optimizations over a generic timestamp approach may be achieved by including a timestamp that tracks when specific columns were last modified. In such an approach, data producing application 120 may pull only those updates that impact the relevant filtering predicate (i.e., the data relevant to user 102 that is refreshing their data) in order to trim the size of the delta response.

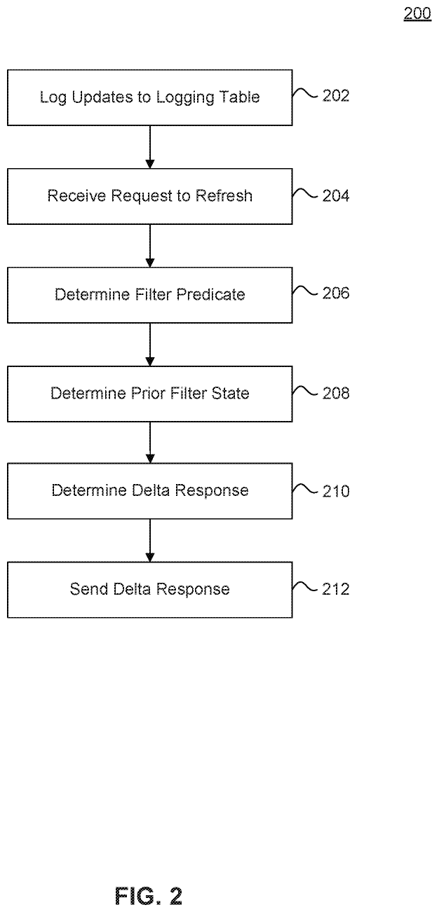

FIG. 2 illustrates a method 200 of determining a delta response by using a change logging approach, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art(s).

In 202, data producing application 120 logs modifications to the database 126 in logging table 132. The nature of the changes that may be made to database 126 may vary depending on the nature of data producing application 120 and application 110. Changes may include insertions, updates, and deletes to table 128 and/or logging table 132. Changes may be made to table 128 via functionality built into the application level, and these changes may be tracked or logged to logging table 132 using database triggers or another automated mechanism. In one illustrative example, user 102 of a particular data producing application 120 may add an additional shop to a “shop” table to reflect the creation of a new shop in the real world. In this example, a new row may be added to the “shop” table. In some applications, changes may be made by a user of application 110, other users, or system administrators. In other applications, changes may occur due to scheduled updates, software releases, or other automated processes. More than one change may occur in step 202. In other words, the updating may be an iterative and continuing process. Thus, hundreds, thousands, or millions of changes or more may occur in database 126 between data refresh requests from application 110. As described above, data producing application 120 may track changes to table 128 and/or logging table 132.

In 204, data producing application 120 may receive a request to refresh from application 110. Such a request to refresh may be communicated by application 110 to data producing application 120 over HTTP or other suitable communication protocol. In an embodiment, application 110 may send a request to refresh upon connecting to an appropriate wireless network. In another embodiment, application 110 may send the request to refresh upon directly interfacing with data producing application, for example, through connecting a USB cable, Ethernet cable, or other physical interface. In another embodiment, requests to refresh may be directly triggered by user 102 in application 110, perhaps using a gesture, e.g., swiping up or left, clicking a refresh indicator, or other suitable user input. A number of suitable approaches, methodologies, and communication technologies may be employed in order to receive a request to refresh. For example, the request to refresh may employ a RESTful protocol or HTTP. In an embodiment, the request to refresh may include a last refresh timestamp, also referred as the last download time, reflecting the date and time of a prior refresh request from device 104. The request to refresh may also include a filter predicate or appropriate parameters to send to data producing application 120 to allow data application 120 to formulate a filter predicate.

In 206, data producing application 120 may determine the filter predicate applicable to application 110 and user 102. In an embodiment, the filter predicate may be contrived, configured, or stored locally on device 104 and/or within application 110 and transmitted to data producing application 120 in step 204. In another embodiment, data producing application 120 may build or otherwise determine an appropriate filter predicate based on parameters received in the request to refresh in 204. The filter predicate may be a simple or compound predicate used to limit the data retrieved to the data that user 102 has permission to access.

In 208, data producing application 120 determines a prior filter state for a table or set of tables from table 128 and/or logging table 132. The prior filter state reflects the state of the data when the user last refreshed or downloaded the data. The nature of the tables will vary based on the character of data producing application 120. In some embodiments, more than one prior filter state may need to be determined, i.e., a filter state for each relevant table 128. Data producing application may retrieve the prior filter state by examining logging table 132 to determine actions that occurred after the most recent download. Data producing application 120 may create an appropriate view by which to examine this prior filter state. This view will be referred to below as item_previous_state, but this name is arbitrary and the view could be named according to any appropriate naming convention. One sample, merely exemplary SQL query to pull item_previous_state follows, however, in other embodiments, item_previous_state may be pulled using other code/pseudocode/algorithms:

```
CREATE VIEW item_previous_state AS
SELECT ID,
CASE WHEN total_count = included_count AND min_modified <
{last_download_start}
    THEN ‘Y’
CASE WHEN included_count = 0
    THEN ‘N’
ELSE NULL END has_row
FROM (
    SELECT
      log_1.ID ID,
      MIN (modified) min_modified,
      COUNT(*) total_count,
      SUM (included) included_count
    FROM (
          SELECT
                log_1.ID ID,
                log_1.modified modified,
            CASE WHEN log_1.is_deleted = ‘N’ AND {filter
            predicate}
                  THEN 1
                  ELSE 0 END included
                  FROM (
                        SELECT log_1.*
                  FROM (
                            SELECT distinct (recent.ID) ID
                        FROM item_log recent_1
                        WHERE recent_1.modified >=
                        {last_download_start}
                        ) recent_keys
                  JOIN item_log log_1
                        ON log_1.ID = recent_keys.ID
                  WHERE log_1.modified > = MIN
                  ({last_download_start},
                        (SELECT MAX (preexisting_1.modified)
                        FROM item_log preexisting_1
                        WHERE preexisting_1.ID = log_1.ID
                        AND preexisting_1.modified <
                        {last_download_start}
                        )
                  AND log_1.modified <= {last_download_end}
                  ) GROUP BY log_1.ID
      )
)
```

In the above example, the inner SELECT statement evaluates the filter predicate for each time the row was updated between (last_download_start) and (last_download_end). The aggregates and case expressions in the outer expression then consolidate the many results returned by the inner SELECT statement into a single item_previous_state while erring on the side of caution to avoid data loss. This is necessary because when there are updates made to the data while the previous download was taking place, ambiguity may exist in the calculation.

In 210, data producing application 120 determines the delta response by comparing the prior filter state determined in 208 to the current data state as existing in database 126 and/or table 128. The delta response may include an is_deleted flag (i.e., a tombstone), and the data update to apply locally. One sample, merely exemplary view used to determine the delta response follows, however, in other embodiments, the delta response may be determined using other code/pseudocode/algorithms:

```
SELECT t1.is_deleted, t3.* FROM item_log t1
JOIN item_previous_state t2
      ON t2.ID = t1.ID
LEFT OUTER JOIN item t3
      ON t3.ID = t1.ID
WHERE t1.modified = (SELECT MAX(modified) FROM item_log
WHERE ID = t1.ID)
AND {filter_prediciate} OR t2.has_row = ‘Y’
OR t2.has_row IS NULL
```

In 212, data producing application 120 transmits the delta response determined in 210 to application 110 and/or device 104. Such a transmission may employ HTTP or other suitable communication protocol to send the data. Then, application 110 may apply the delta of changes to its locally stored data to bring the dataset into an updated state.

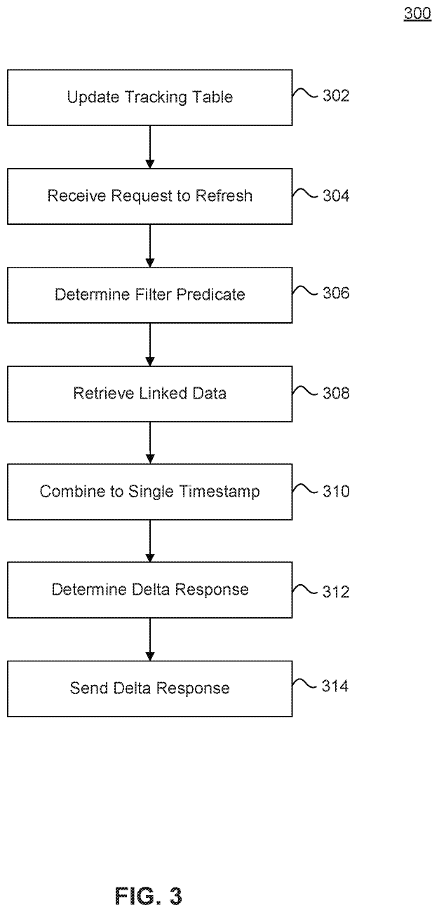

FIG. 3 illustrates a method 300 of determining a delta response via an association-based approach, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

In 302, data producing application 120 logs modifications to the database 126 in tracking table 130. The nature of the changes that may be made to database 126 may vary depending on the nature of data producing application 120 and application 110. Changes may include insertions, updates, and deletes to table 128 and/or tracking table 1320. Changes may be made to table 128 via functionality built into the application level, and these changes may be tracked or logged to tracking table 130 using database triggers or another automated mechanism. In one illustrative example, user 102 of a particular data producing application 120 may add an additional shop to a “shop” table to reflect the creation of a new shop in the real world. In this example, a new row may be added to the “shop” table. In some applications, changes may be made by a user of application 110, other users, or system administrators. In other applications, changes may occur due to scheduled updates, software releases, or other automated processes. More than one change may occur in step 202. In other words, the updating may be an iterative and continuing process. Thus, hundreds, thousands, or millions of changes or more may occur in database 126 between data refresh requests from application 110. As described above, data producing application 120 may track changes to table 128 and/or tracking table 130.

The changes logged to tracking table 130 may be contrasted with those made to logging table 132. The changes to tracking table 130 may only track associations or links between primary-key-joined data tables. A link is a chain of primary key associations linking tables in a chain. For example, a user may be associated with an organization via a primary key, the organization may be associated with a region via a primary key, and the region may be associated with shops via a primary key. In such an example, a user may be linked to a shop by a chain of 3 links: user->organization->region->shop. In the context of association-based logging, changes between links may be tracked along with the modified time and isDeleted flag for the link.

In 304, data producing application 120 may receive a request to refresh from application 110. Such a request to refresh may be communicated by application 110 to data producing application 120 over HTTP or other suitable communication protocol. In an embodiment, application 110 may send a request to refresh upon connecting to an appropriate wireless network. In another embodiment, application 110 may send the request to refresh upon directly interfacing with data producing application, for example, through connecting a USB cable, Ethernet cable, or other physical interface. In another embodiment, requests to refresh may be directly triggered by user 102 in application 110, perhaps using a gesture, e.g., swiping up or left, clicking a refresh indicator, or other suitable user input. A number of suitable approaches, methodologies, and communication technologies may be employed in order to receive a request to refresh. For example, the request to refresh may employ a RESTful protocol or HTTP. In an embodiment, the request to refresh may include a last refresh timestamp, also referred as the last download time, reflecting the date and time of a prior refresh request from device 104. The request to refresh may also include a filter predicate or appropriate parameters to send to data producing application 120 to allow data application 120 to formulate a filter predicate.

In 306, data producing application 120 may determine the filter predicate applicable to application 110 and user 102. In an embodiment, the filter predicate may be contrived, configured, or stored locally on device 104 and/or within application 110 and transmitted to data producing application 120 in step 204. In another embodiment, data producing application 120 may build or otherwise determine an appropriate filter predicate based on parameters received in the request to refresh in 204. The filter predicate may be a simple or compound predicate used to limit the data retrieved to the data that user 102 has permission to access.

In 308, data producing application 120 retrieves the linked data stored in tracking table 130. The linked data pulls only the data related to table 128 through relevant primary-key-associated timestamps. The linked data may include multiple records that could impact a user's delta response. In the above example of user->organization->region->shop, a user could lose access to a shop via a deletion to the organization, the region, or the shop. The linked data may include such redundancies. For example, if both the organization and region were changed for a user since the last refresh, the linked data may include a timestamp for both deletions.

In 310, data producing application 120 reduces the linked data to a single timestamp. This reduction or distillation takes advantage of three observations:
(1) a chain is deleted if any individual link is deleted. All links must be connection for the full chain to be connection;
(2) If a chain is not deleted, then the last-modified time of the chain is the most recent last-modified time of each of the individual links. The full chain was not connected until the last of its links is connected; and
(3) If a chain is deleted, then the last-modified time of the chain is the oldest last modified time of each of its individual deleted links. The chain was broken when the first link was broken.
   These observations allow the linked data from the tracking tables, pulled in 308, to be joined into a single row.

In 312, data producing application 120 determines the delta response by aggregating the multiple rows back to a single unique row. This aggregation takes advantage of three additional observations:
(1) A first terminus in a chain is connected to a second terminus if there is at least one unbroken chain from the first terminus to the second;
(2) If there is at least one unbroken chain from a first terminus to a second terminus, then the last modified time is the oldest time from each of the unbroken chains; and
(3) If all the chains are broken, then the last-modified time is the most recent last modified time from each of the broken chains.

One sample, merely exemplary view used to aggregate the multiple rows back to a single unique row follows, however, in other embodiments, the aggregation may be accomplished using other code/pseudocode/algorithms. For clarity, this example query refers to the first terminus as the user table and the second terminus as the shop, as in the example chain described above:

```
SELECT t5.userID, t5.shopID,
CASE
      WHEN t5.activeLinks > 0 THEN t5.linkInsertTime
      ELSE t5.linkDeleteTime
      END lastModified,
CASE
      WHEN t5.activeLinks > 0 THEN ‘N’
      ELSE ‘Y’
      END isDeleted
FROM (
      SELECT t4.userID, t4.shopID,
      MIN (linkInsertTime) linkInsertTime,
      MAX (linkDeleteTime) linkDeleteTime,
      SUM (activeLinks) activeLinks
      FROM (
            SELECT t1.userID, t3.shopID,
```

| | |
|---|---|
| getUpsertTime3( | t1.isDeleted, t1.lastModified, |
| | t2.isDeleted, t2.lastModified, |
| | t3.isDeleted, t3.lastModified) as |
| | linkInsertTime, |
| getDeleteTime3( | t1.isDeleted, t1.lastModified, |
| | t2.isDeleted, t2.lastModified, |
| | t3.isDeleted, t3.lastModified) as |
| | linkDeleteTime, |

```
            CASE
                  WHEN t1.isDeleted=‘Y’ OR t2.isDeleted=‘Y’
                  OR t3.isDeleted=‘Y’ THEN 0
                  ELSE 1
                  END as activeLinks
            FROM userOrganizationTracking t1
            JOIN organizationRegionTracking t2
                  ON t2.organizationID = t1.organizationID
            JOIN shopRegionTracking t3
                  ON t3.regionID = t2.regionID
      ) t4 GROUP by t4.userID, t4.shopID
) t5
```

In 314, data producing application 120 transmits the delta response determined in 210 to application 110 and/or device 104. Such a transmission may employ HTTP or other suitable communication protocol to send the data. Then, application 110 may apply the delta of changes to its locally stored data to bring the dataset into an updated state.

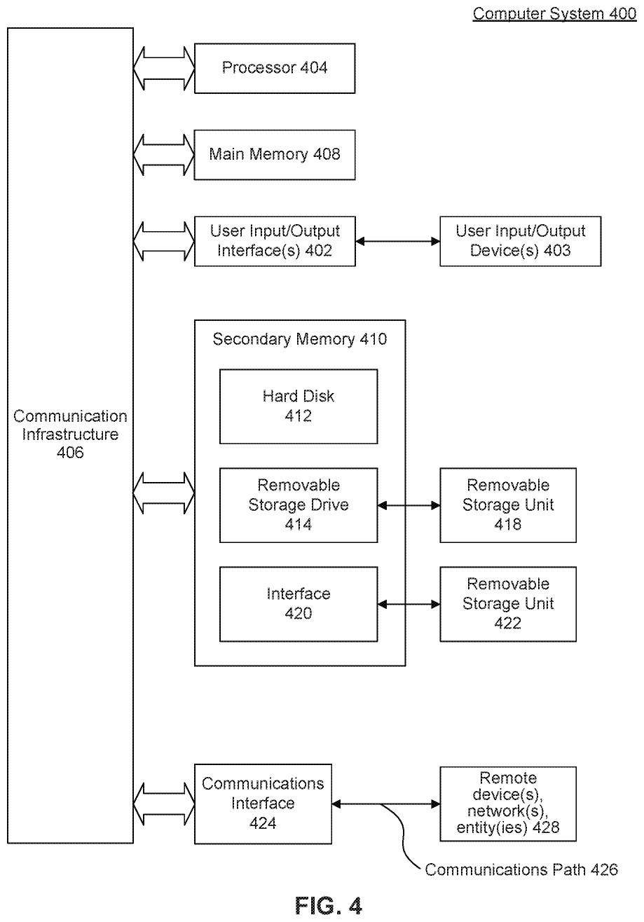

FIG. 4 is an example computer system useful for implementing various embodiments. Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 402, such as monitors, keyboards, pointing devices, etc., which may communicate with communication infrastructure or bus 406 through user input/output device(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, by a data producing application, a request to refresh data from a data consuming application, wherein the request to refresh data comprises a last download time and a filtering predicate, and wherein the data producing application logs a change made to a table in a logging table;
determining, by the data producing application, a delta response based on the last download time, the logging table, and the filtering predicate, wherein the delta response comprises a set of changes to the table that occurred since the last download time; and
sending, by the data producing application, the delta response to the data consuming application,
wherein at least one of the receiving, determining, and sending are performed by one or more computers.

2. The method of claim 1, further comprising:
writing, by the data producing application, a change log in the logging table upon a change to the table, wherein the change log comprises a delete flag and a modified timestamp;
determining, by the data producing application, a prior change log, wherein the prior change log occurred prior to the last download time;
determining, by the data producing application, a prior filter state based on the filtering predicate and the prior change log;
determining, by the data producing application, a current filter state based on the filtering predicate; and
comparing, by the data producing application, the prior filter state to the current filter state to determine the delta response, wherein the delta response includes only changes satisfying the filtering predicate, and wherein the delta response includes only changes not in the prior filter state but in the current filter state or in the prior filter state but not in the current filter state.

3. The method of claim 1, further comprising:
writing, by the data producing application, a change log in a tracking table upon a change to the database, wherein the change log comprises a delete flag and a modified timestamp,
determining, by the data producing application, a primary key association based on the change;
retrieving, by the data producing application, linked data based on the filtering predicate, the change log, and the primary key association;
combining, by the data producing application, the linked data to form a first single timestamp; and
aggregating, by the data producing application, the single timestamp with a second single timestamp into the delta response.

4. The method of claim 1, further comprising:
running the data consuming application on a mobile device;
storing an offline copy of the table on the mobile device;
sending the request to refresh data upon receiving internet connectivity; and
updating the offline copy of the table based on the received delta response.

5. The method of claim 1, wherein the data producing application uses an open data access protocol to produce data in response to a hypertext transfer protocol request.

6. The method of claim 1, wherein the data producing application logs a change to the logging table when a change is made to the table using a trigger.

7. The method of claim 1, wherein the filtering predicate is a compound predicate.

8. A system, comprising:
a memory; and
at least one processor coupled to the memory, the at least one processor configured to:
receive a request to refresh data from a data consuming application to a data producing application, wherein the request to refresh data comprises a last download time and a filtering predicate, and wherein the data producing application logs a change made to a table in a logging table;
determine a delta response based on the last download time, the logging table, and the filtering predicate, wherein the delta response comprises a set of changes to the table that occurred since the last download time; and
send the delta response to the data consuming application.

9. The system of claim 8, the at least one processor further configured to:
write a change log in the logging table upon a change to the table, wherein the change log comprises a delete flag and a modified timestamp;
determine a prior change log, wherein the prior change log occurred prior to the last download time;
determine a prior filter state based on the filtering predicate and the prior change log;
determine a current filter state based on the filtering predicate; and
compare the prior filter state to the current filter state to determine the delta response, wherein the delta response includes only changes satisfying the filtering predicate, and wherein the delta response includes only changes not in the prior filter state but in the current filter state or in the prior filter state but not in the current filter state.

10. The system of claim 8, the at least one processor further configured to:
write a change log in a tracking table upon a change to the table, wherein the change log comprises a delete flag and a modified timestamp;
determine a primary key association based on the change;
retrieve linked data based on the filtering predicate, the change log, and the primary key association;
combine the linked data to form a first single timestamp; and
aggregate the single timestamp with a second single timestamp into the delta response.

11. The system of claim 8, the at least one processor further configured to:
run the data consuming application on a mobile device;
store an offline copy of the table on the mobile device;
send the request to refresh data upon receiving internet connectivity; and
update the offline copy of the database based on the received delta response.

12. The system of claim 8, wherein the data producing application uses an open data access protocol to produce data in response to a hypertext transfer protocol request.

13. The system of claim 8, wherein the data producing application logs a change to the logging table when a change is made to the table using a trigger.

14. The system of claim 8, wherein the filtering predicate is a compound predicate.

15. A non-transitory computer-readable device having instructions stored thereon that, when executed by at least one computing device, cause the at least one computing device to perform operations comprising:
receiving, by a data producing application, a request to refresh data from a data consuming application, wherein the request to refresh data comprises a last download time and a filtering predicate, and wherein the data producing application logs a change made to a table in a logging table;
determining, by the data producing application, a delta response based on the last download time, the logging table, and the filtering predicate, wherein the delta response comprises a set of changes to the table that occurred since the last download time; and
sending, by the data producing application, the delta response to the data consuming application.

16. The non-transitory computer-readable device of claim 15, the operations further comprising:
writing a change log in the logging table upon a change to the table, wherein the change log comprises a delete flag and a modified timestamp;
determining a prior change log, wherein the prior change log occurred prior to the last download time;
determining a prior filter state based on the filtering predicate and the prior change log;
determining a current filter state based on the filtering predicate; and
comparing the prior filter state to the current filter state to determine the delta response, wherein the delta response includes only changes satisfying the filtering predicate, and wherein the delta response includes only changes not in the prior filter state but in the current filter state or in the prior filter state but not in the current filter state.

17. The non-transitory computer-readable device of claim 15, the operations further comprising:
writing a change log in a tracking table upon a change to the table, wherein the change log comprises a delete flag and a modified timestamp;
determining a primary key association based on the change;
retrieving linked data based on the filtering predicate, the change log, and the primary key association;
combining the linked data to form a first single timestamp; and
aggregating the single timestamp with a second single timestamp into the delta response.

18. The non-transitory computer-readable device of claim 15, the operations further comprising:
running the data consuming application on a mobile device;
storing an offline copy of the table on the mobile device;
sending the request to refresh data upon receiving internet connectivity; and
updating the offline copy of the table based on the received delta response.

19. The non-transitory computer-readable device of claim 15, wherein the data producing application uses an open data access protocol to produce data in response to a hypertext transfer protocol request.

20. The non-transitory computer-readable device of claim 15, wherein the data producing application logs a change to the logging table when a change is made to the table using a trigger.
